(19) United States
(12) Patent Application Publication
(10) Pub. No.: US 2011/0244091 A1
(43) Pub. Date: Oct. 6, 2011

(54) Process for producing yogurt and cereal bars, rice pudding bars, and milk and cereal bars that provide handheld milk and cereal breakfasts

(76) Inventors: Harold W. Zukerman, Northbrook, IL (US); Rachel B. Zukerman, Northbrook, IL (US)

(21) Appl. No.: 12/798,079

(22) Filed: Mar. 30, 2010

(51) Int. Cl. A23L 1/182

(52) U.S. Cl. 426/281

(57) ABSTRACT

The present invention relates to a two-step cooking process for producing yogurt and cereal bars, rice pudding bars, and milk and cereal bars having surfaces and interiors comprised of soft, moist, fully-cooked milk-infused grain-chunks. Said bars provide handheld milk and cereal breakfasts. In the first cooking step, grain-chunks are only partially-cooked in a continuous-cooker at about 212° F. while being infused with 1.5 to 4 times as much fluid-milk before said partially-cooked, milk-infused grain-chunks are deposited from said cooker and allowed to flow onto a conveyor belt as a thick-sheet. Food particles are sprinkled onto the surface of said sheet before it is cut into bar-shaped units. In the second cooking step, the shaped-units are baked in a continuous-oven at temperatures above 275° F. until their partially-cooked grain-chunks become fully-cooked. The units are then cooled to prevent overcooking the fully-cooked grain-chunks.

### BACKGROUND OF THE INVENTION

The process of the present invention makes yogurt and cereal bars, rice pudding bars and milk and cereal bars having surfaces and interiors comprised of soft, moist, fully-cooked, milk-infused grain-chunks. Said bars provide handheld milk and cereal breakfasts.

The prior art teaches how to make yogurt, a cultured fluid-milk product made by bacterial fermentation of fluid-milk. The prior art also teaches how to make rice pudding by cooking rice grains with fluid-milk. The prior art also teaches how to make a bowl of milk and cereal with 130 grams of refrigerated fluid-milk and 30 grams of dry, low density cereal pieces (80% fluid-milk and 20% dry cereal pieces). These foods are fluid and have to be eaten with a spoon. They cannot be eaten handheld.

The prior art also teaches how to make soft-baked oatmeal cookies by mixing oatmeal, wheat flour, water and sugar into an uncooked, room temperature dough-mass which is deposited as cookie-shapes and then oven-baked. Soft-baked oatmeal cookies cannot provide a milk and cereal breakfast because they are not formulated with milk.

The prior art also teaches several processes for making intermediate moisture cereal bars: one process teaches that cereal flour is extruded and expanded into small-sized, low-density cereal pieces which are then coated with a sticky-syrup so they stick to each other when they are formed into bar-shaped units. Cereal bars made with these low-density cereal pieces cannot provide a milk and cereal breakfast because they are not formulated with milk. Another process for making intermediate moisture cereal bars teaches that small pieces of cereal grains can be infused with soluble-solids such as glycerin, sugar and corn syrup and then formed into bar-shaped units. Cereal bars made with glycerin infused cereal grains are not formulated with milk. In fact, the process and preservation system developed for making intermediate moisture cereal bars cannot make milk and cereal bars that provide handheld milk and cereal breakfasts.

U.S. Pat. No. 6,103,283 Zukerman et al teaches a process for making milk and cereal products in which the cereal grains are “fully-cooked inside the cooker”. The fact is, cereal grains that require multiple cooking steps should not be fully-cooked in the first step of the process because these already fully-cooked cereal grains (which are still at high temperatures when they leave the cooker) continue to cook while they are subsequently shaped into units and then oven-baked at even higher temperatures. Properly cooking cereal grains, such as rice grains, is very important because if the rice grains are over-cooked, they can change from being individual, soft-moist grains into ruptured rice granules that have a pasty, homogeneous consistency. Also, U.S. Pat. No. 6,103,283 teaches heating the units until their water activity is lower than 0.85 whereas all the products of the present invention have water activities that are higher than 0.85.

### BRIEF SUMMARY OF THE INVENTION

The present invention relates to a two-step cooking process for producing yogurt and cereal bars, rice pudding bars, and milk and cereal bars having surfaces and interiors comprised of soft, moist, fully-cooked milk-infused grain-chunks. Said bars provide handheld milk and cereal breakfasts. In the first cooking step, grain-chunks are only partially-cooked in a continuous-cooker at about 212° F. while simultaneously being infused with 1.5 to 4 times as much flavored fluid-milk before said partially-cooked, milk-infused grain-chunks are deposited from said cooker and flow onto a conveyor belt as a thick-sheet. Food particles are then sprinkled onto the surface of said sheet before said sheet is cut into bar-shaped units. When cookie-shaped units comprised of partially-cooked milk-infused grain-chunks are made, said cookie-shaped units are deposited across the entire width of the belt-conveyor.

In the second cooking step, the shaped-units, comprised of partially-cooked, milk-infused grain-chunks, are baked in a continuous-oven at temperatures above 275° F. until said partially-cooked grain-chunks become fully-cooked. Said units are then immediately cooled to prevent overcooking the fully-cooked grain-chunks.

It is the primary object of the present invention to produce fully-cooked yogurt and cereal bars and cookies, rice pudding bars and cookies, and milk and cereal bars and cookies that children can eat interchangeably with traditional bowls of milk and cereal.

It is another object of the present invention to produce fully-cooked yogurt and cereal bars and cookies, rice pudding bars and cookies, and milk and cereal bars and cookies with the same process equipment and similar ratios of fluid-milk to dry cereal as in bowls of milk and cereal so said bars can be price-competitive with bowls of milk and cereal.

It is still another object of the present invention to produce fully-cooked yogurt and cereal bars and cookies, rice pudding bars and cookies, and milk and cereal bars and cookies with the same process equipment and with similar ratios of fluid-milk to dry cereal as in bowls of milk and cereal using whole cereal grains that provide cookies (FIG. 4) and bars (FIG. 5) that have soft, moist; fully-cooked, milk-infused grain-textures.

It is another object of the present invention to produce fully-cooked yogurt and cereal bars and cookies, rice pudding bars and cookies, and milk and cereal bars and cookies with the same process equipment and similar ratios of fluid-milk to dry cereal as in bowls of milk and cereal using grain-chunks which are made by cutting whole cereal grains into numerous small, similarly-sized pieces of grain. Grain chunks are desirable for this application because they can be cooked and infused with fluid-milk twice-as-fast as whole cereal grains while still providing cookies (FIG. 4) and bars (FIG. 5) that have soft, moist, fully-cooked, milk-infused grain-textures.

### BRIEF DESCRIPTION OF THE DRAWINGS

FIG. 1 illustrates an example of a whole cereal grain (1) having an outer surface (2) and a grain center (3) and showing the comparatively large distance between the surface of the grain (2) and the center of the grain (3).

FIG. 2 illustrates the whole cereal grain of FIG. 1 cut into smaller sized-grain-chunks that have more faceted surface areas (2) and (3). Also, there is a comparatively smaller distance between the surface of the grain (2) and (3) and the center of the grain (1). (These differences allow the smaller sized grain-chunks to be cooked and infused with fluid-milk twice as fast as whole cereal grains.)

FIG. 3 illustrates an example of a cereal and milk cookie having a surface and interior comprised of soft, moist, fully-cooked, milk-infused grain-chunks (1) and (2) with raisins on top (3); said cookie is made in accordance with the process of the present invention.

FIG. 4 illustrates an example of a milk and cereal bar (1) having an outer surface and interior comprised of soft, moist, fully-cooked, milk-infused grain-chunks (2) with chocolate chips on top (3); said bar is made in accordance with the process of the present invention.

FIG. 5 illustrates the process steps and process equipment used for making yogurt and cereal bars, rice pudding bars and milk and cereal bars comprised of soft, moist, fully-cooked, milk-infused grain-chunks.

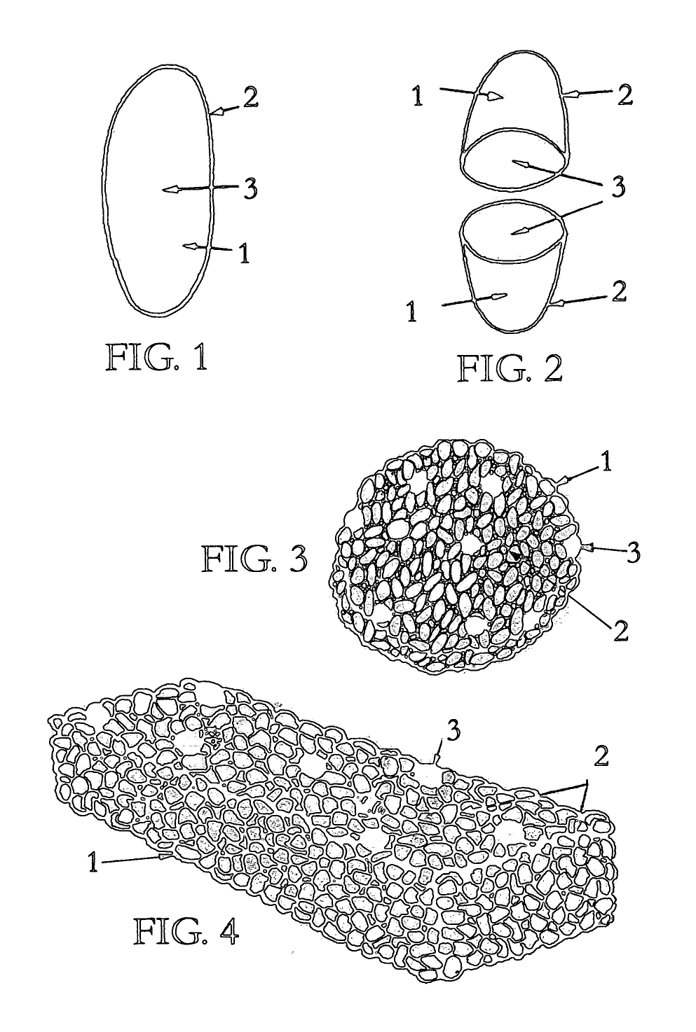

### DETAILED DESCRIPTION OF THE PREFERRED EMBODIMENT

The present invention relates to a two-step cooking process for producing yogurt and cereal bars and cookies, rice pudding bars and cookies, and milk and cereal bars and cookies having surfaces and interiors comprised of soft, moist, fully-cooked milk-infused grain-chunks. Said bars and cookies provide handheld milk and cereal breakfasts. In the first cooking step, grain-chunks are only partially-cooked in a continuous-cooker at about 212° F. while simultaneously being infused with 1.5 to 4 times as much flavored fluid-milk before said partially-cooked, milk-infused grain-chunks are deposited from said cooker and allowed to flow onto a conveyor belt as a thick-sheet. Food particles are then sprinkled onto the surface of said sheet before said sheet is cut into rectangular or square shaped units.

When circular cookies are made, the partially-cooked, milk-infused grain-chunks are transferred from said cooker's discharge (9) directly into a cookie depositor (not shown) which deposits circular cookie shaped units across the entire width of the belt-conveyor.

In the second cooking step, the shaped-units, comprised of partially-cooked, milk-infused grain-chunks, are baked in a continuous-oven at temperatures above 275° F. until said partially-cooked grain-chunks become fully-cooked. Said units are then immediately cooled to prevent overcooking the fully-cooked grain-chunks.

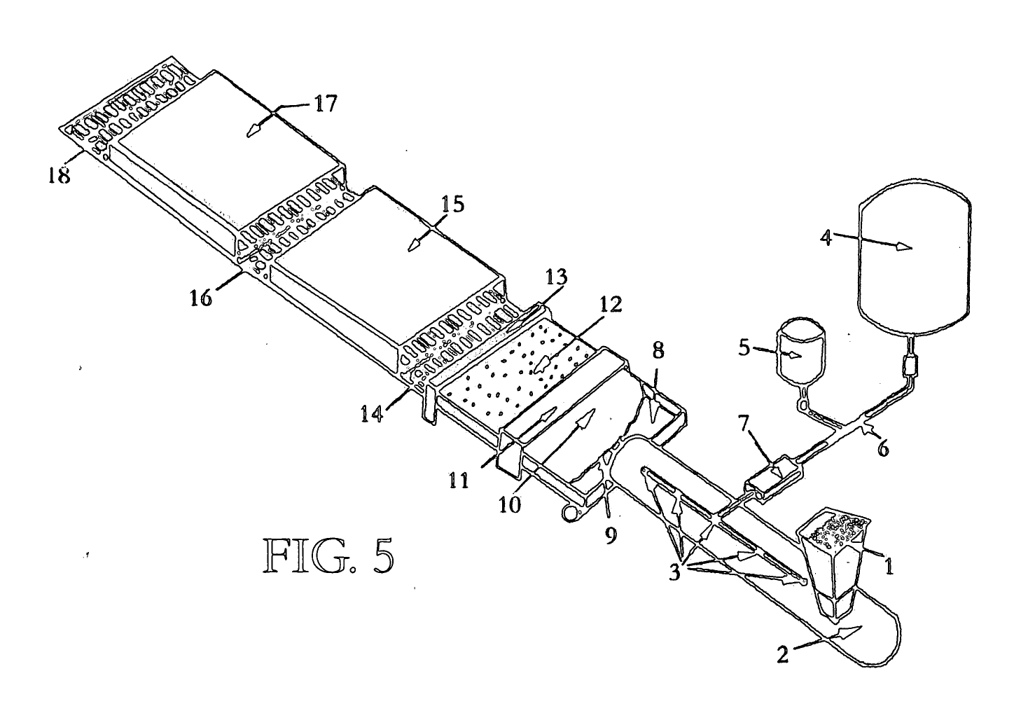

FIG. 5 illustrates the two-step cooking technique of the process of the present invention. In the first step of the process, grain-chunks (1) and hot flavored fluid-milk (3) are both metered into a continuous-cooker (2) where said grain-chunks are partially-cooked with 1.5 to 4 times as much hot, flavored fluid-milk (3).

The hot flavored fluid-milk (3) is prepared by mixing a flavor solution (5) comprised of flavors, sweeteners, spices, water binders and starch complexing agents into the refrigerated fluid-milk (4) and then heating said flavored fluid-milk (3) to 212° F. with a continuous heat-exchanger (7) before injecting it into the continuous-cooker (2) at multiple locations throughout the length of said continuous-cooker. Said flavored, fluid-milk is continuously infused into the grain-chunks as they are moved from the entrance of the cooker (2) to the cookers discharge (9) and flow onto a belt-conveyor (8) as a thick sheet (10). A feeder (11) deposits particles such as chocolate chips, raisins and/or natural or artificial fruit chips onto the surface of the thick-sheet of partially-cooked, milk-infused grain-chunks (12) before said sheet is cut with cutters (13) into rectangular or square shaped-units (14). If desired, in the process of the present invention, the feeder (11) can also deposit chocolate chips, raisins and/or natural or artificial fruit chips onto the surface of the thick-sheet of partially-cooked, milk-infused grains (12) after said sheet is cut into rectangular or square shaped-units (14).

In the process of the present invention, circular-shaped cookies (as illustrated in FIG. 3) comprised of soft, moist, fully-cooked, milk-infused grain-chunks can also be made with the same process equipment, processing steps and with the same ratios of fluid-milk to cereal as in bowls of milk and cereal. However, said cookie-shapes are made by transferring the partially-cooked, milk-infused grain-chunks from the continuous-cooker's discharge (9) directly into the hopper of a cookie depositor (not illustrated) which deposits cookie-shaped units, comprised of partially-cooked, milk-infused grain-chunks, across the entire width of the belt-conveyor (10).

In the third step of the process, the bar-shaped units comprised of partially-cooked, milk-infused grain-chunks (14) are moved from the belt-conveyor (8) into a continuous oven (15) and baked at temperatures above 275° F. until their partially-cooked milk-infused grain-chunks become fully-cooked. Then, the bars are cooled and/or frozen in a continuous freezer (17) to stop the cooking process and prevent overcooking the fully-cooked milk-infused grain-chunks. The frozen units (18) are then stored frozen.

The products of the present invention can be made with either whole cereal grains or grain-chunks. Grain-chunks are made by cutting cereal grains into several smaller but similar-sized pieces of cereal grains; said cereal grains can be selected from the group consisting of oats, wheat, rice, corn or combinations thereof. Grain-chunks are the preferred choice for making the products of the present invention because they can be cooked and infused with fluid-milk twice as fast as whole cereal grains while still providing milk and cereal cookies (illustrated in FIG. 3) and milk and cereal bars (illustrated in FIG. 4) that have surfaces and interiors comprised of soft, moist, fully-cooked milk-infused grain-chunks.

The fluid-milk used in the process of the present invention can be selected from the group consisting of cultured fluid-milk produced by bacterial fermentation of fluid-milk, or full-fat, low-fat or fat-free fluid-milk, concentrated fluid-milk or dry, powdered milk re-hydrated with water, or combinations thereof.

In the process of the present invention, the flavor solution (5) is made with flavors (such as chocolate, vanilla or fruit flavors), spices, sweeteners such as sugar or non caloric sweeteners, water binders and starch-complexing agents such as lecithin and monoglycerides.

In the process of the present invention, steam-jacketed, tilt-type batch-cookers can be used instead of a continuous cooker to partially cook the cereal grains and infuse them with milk in order to make the products of the present invention. When steam-jacketed, batch-cookers are used, the flavored fluid-milk comprised of flavors, sweeteners, water binders and starch complexing agents is preheated to 212° F. before it is added with the grains to the batch-cooker.

In the process of the present invention, the bars and cookies comprised of soft, moist, fluid-milk-infused grain chunks are formulated with 1.5 to 4 times as much fluid-milk as grain-chunks or cereal grains.

The preferred ratio of fluid-milk to cereal grains in the products of the present invention is four times as much fluid-milk as cereal grains. This ratio of fluid-milk to cereal grains was selected because the traditional bowl of milk and cereal is made with four times as much fluid-milk as dry, low-density cereal. However, some consumers prefer to make their bowls of milk and cereal breakfast with less fluid-milk. The range of 1.5 to 4 times as much fluid-milk as cereal grains or grain chunks in the products of the present invention satisfies most milk and cereal breakfast consumers.

The following three examples will further illustrate the invention, but it is not intended that the invention be limited to the details set forth therein.

All of the products of the present invention are made with the same process equipment and the same process steps illustrated in FIG. 5 and discussed in the detailed description of this preferred embodiment. The only differences between the following three examples listed below are: 1) the choice of grains or grain blends, 2) the type of fluid-milk selected, 3) the selected flavor solution, 4) the type of food particles, and 5) the ratio of fluid-milk to cereal grains.

### Example 1

### Chocolate Flavored Milk and Cereal Bars

Grains: 33.3% Rice chunks, 33.3% Wheat chunks, and 33.3% Oat chunks
Fluid-Milk: A blend of full-fat fluid-milk and hydrated fat-free dry milk solids

### Flavor Solution: Chocolate

### Food Particles: Chocolate Chips

### Ratio of Fluid-Milk to Grains: 80% Fluid-milk to 20% Mixed Grain-Chunks

### Example 2

### Peach-Flavored Yogurt and Cereal Bars

### Grains: 3.3% Rice Chunks, 33.3% Wheat Chunks and 33.3% Oat Chunks

Fluid-Milk: Yogurt (a cultured fluid-milk produced by bacterial fermentation of milk)

### Flavor Solution: Peach

### Food Particles: Golden Raisins

### Ratio of Fluid-Yogurt To Grain-Chunks: 80% Fluid-Yogurt to 20% Grain-Chunks

### Example 3

### Rice-Pudding Bars

### Grains: 100% White Rice Grains

Fluid-Milk: Fat-free Fluid-milk (prepared by hydrating dry-milk solids with water)

### Flavor Solution: Vanilla

### Food Particles: Raisins

### Ratio of Fluid-Milk to Grains: 70% Fluid-milk to 30% White Rice Grains.

It is to be understood that the above described process and the above examples are simply illustrative of the application of principles of the invention and many other modifications may be made without departing from the spirit and scope of the invention The embodiments of the invention in which an exclusive property or privilege is claimed are defined as follows:

We claim:

1. A process for making yogurt and cereal bars, rice pudding bars and milk and cereal bars having surfaces and interiors comprised of soft, moist, fully-cooked, milk-infused grain-chunks; said process comprising the steps of:
(a) partially-cooking grain-chunks with fluid-milk in a continuous-cooker at about 212° F. while simultaneously infusing them with 1.5 to 4 times as much fluid-milk before said hot, partially-cooked, milk-infused grain-chunks flow from said cooker onto a belt-conveyor as a thick-sheet;
(b) cutting said sheet of hot, partially-cooked, milk-infused grain-chunks into individual bar-shaped units;
(c) oven-baking said bar-shaped units at temperatures above 275° F. until their partially-cooked, milk-infused grain-chunks become fully-cooked; and then (d) cooling said bar-shaped units to stop cooking the now fully-cooked milk-infused grain-chunks.

2. The process of claim 1 wherein grain-chunks are made from cereal grains selected from the group consisting of oats, wheat, rice, corn or combinations thereof.

3. The process of claim 1 wherein the fluid-milk is selected from the group consisting of cultured fluid-milk produced by bacterial fermentation of fluid-milk, or full-fat, low-fat or fat-free fluid-milk, concentrated fluid-milk or dry, powdered milk re-hydrated with water, or combinations thereof.

4. The process of claim 1 which further comprises mixing a flavor solution comprised of flavors, sweeteners, spices, water binders and starch complexing agents into the fluid-milk and then heating said flavored fluid-milk to about 212° F. before injecting it into the continuous-cooker.

5. The process of claim 1 which further comprises depositing food particles such as chocolate chips, raisins and/or natural or artificial fruit chips onto the surface of the thick-sheet of partially-cooked, milk-infused grain-chunks either before or after said sheet is cut into rectangular or square shaped-units.

6. The process of claim 1 which further comprises using a steam jacketed batch-cooker equipped with scraper-agitators instead of the continuous-cooker to partially-cook the grain-chunks while simultaneously infusing them with 1.5 to 4r times as much fluid-milk.

7. The process of claim 1 which further comprises freezing the shaped units.

8. A process for making yogurt and cereal cookies, rice pudding cookies and milk and cereal cookies having surfaces and interiors comprised of soft, moist, fully-cooked, milk-infused grain chunks; said process comprising the steps of:
(a) partially-cooking grain-chunks in a continuous cooker while they are infused with 1.5 to 4 times as much fluid-milk;
(b) depositing hot circular cookie-shaped units comprised of partially-cooked, milk-infused grain-chunks across the entire width of a belt-conveyor;
(c) oven-baking the cookie-shaped units of at temperatures above 275° F. until their partially-cooked, milk-infused grain-chunks become fully-cooked; and then
(d) Cooling the cookies to stop cooking their fully-cooked grain-chunks.

9. The process of claim 8 which further comprises using a steam jacketed batch-cooker equipped with scraper agitators instead of a continuous cooker to partially-cook the grain-chunks while simultaneously infusing them with 1.5 to 4 to four times as much flavored fluid-milk.

10. The process of claim 8 wherein the grain-chunks are made from grains selected from the group consisting of oats, wheat, rice, corn, oats or combinations thereof.

11. The process of claim 8 which further comprises making circular cookie-shaped units with whole cereal grains selected from the group consisting of oats, wheat, rice, corn, or combinations thereof.

12. The process of claim 8 wherein the fluid-milk is selected from the group consisting of cultured fluid-milk produced by bacterial fermentation of fluid-milk or full-fat, low-fat, fat-free, concentrated fluid-milk, dry, powdered milk re-hydrated with water, or combinations thereof.

13. The process of claim 8 which further comprises freezing the cookie-shaped units.

14. A process for making yogurt and cereal bars, rice pudding bars and milk and cereal bars having surfaces and interiors comprised of soft, moist, fully-cooked, milk-infused cereal grains; said process comprising the steps of:
(a) partially-cooking cereal grains with fluid-milk in a continuous-cooker at about 200° F. while simultaneously infusing them with 1.5 to 4 times as much fluid-milk before said partially-cooked, milk-infused cereal grains flow from said cooker onto a belt-conveyor as a thick-sheet;
(b) cutting said sheet of hot, partially-cooked, milk-infused cereal grains into bar-shaped units;
(c) oven-baking the bar-shaped units at temperatures above 275° F. until their partially-cooked, milk-infused cereal grains become fully-cooked; and then
(d) cooling the bar-shaped units to stop cooking the now fully-cooked milk-infused cereal grains.

15. The process of claim 14 wherein cereal grains are selected from the group consisting of oats, wheat, rice, corn or combinations thereof.

16. The process of claim 14 wherein the fluid-milk is selected from the group consisting of cultured fluid-milk produced by bacterial fermentation of fluid-milk, or full-fat, low-fat or fat-free fluid-milk, concentrated fluid-milk or dry, powdered milk re-hydrated with water, or combinations thereof.

17. The process of claim 14 which further comprises mixing a flavor solution comprised of flavors, sweeteners, spices, water binders and starch complexing agents into the fluid-milk and then heating said flavored fluid-milk to about 212° F. before injecting it into the continuous-cooker.

18. The process of claim 14 which further comprises depositing food particles such as chocolate chips, raisins and/or natural or artificial fruit chips onto the surface of the thick-sheet of partially-cooked, milk-infused cereal grains before or after cutting said sheet into rectangular or square shaped-units.

19. The process of claim 14 which further comprises using a steam-jacketed batch-cooker equipped with scraper-agitators instead of the continuous-cooker to partially-cook the cereal grains while simultaneously infusing them with 1.5 to 4 times as much flavored fluid-milk.

20. The process of claim 14 which further comprises freezing the shaped units.
